(19) United States
(12) Patent Application Publication
(10) Pub. No.: US 2008/0005058 A1
(43) Pub. Date: Jan. 3, 2008

(54) System and method for optimizing allocation of resources

(75) Inventors: Jeffrey Scott Olander, Wildwood, MO (US); Thomas Joseph Bene, Des Peres, MO (US); John Kevin King, Fridley, MN (US); Victoria Leigh Hoss, Brooklyn Park, MN (US)

Correspondence Address: PILLSBURY WINTHROP SHAW PITTMAN LLP, P.O BOX 10500, McLean, VA, 22102, US

(73) Assignee: TEXTRON FINANCIAL CORPORATION, Providence, RI (US)

(21) Appl. No.: 11/478,039

(22) Filed: Jun. 29, 2006

(51) Int. Cl. G06F 17/30

(52) U.S. Cl. 707/1

(57) ABSTRACT

A system and method are disclosed for optimizing allocation of an entity's resources based on an existing set of the entity's geographical service territories, wherein each territory includes both existing and potential customers. A plurality of territory-selection criteria are established and existing and potential customer data are compiled for each of the entity's existing territories. Customer data are quantified, and an overall rating indicative of the relative level of compliance between each existing territory's customer data and the territory-selection criteria is calculated. Based on the magnitude of the average overall rating for all existing territories, the geographical boundaries of at least one of the entity's existing territories are reconfigured to generate a new set of territories in such a way as to reduce the average rating. The process is then iteratively repeated until it is determined that further reductions in the average rating would not justify additional reconfiguration of the territories.

### FIELD OF INVENTION

This invention relates generally to systems and methods for optimizing allocation of business resources and, more particularly, to quantification of potential business opportunities in such a way as to allow optimal geographical distribution of those resources, including the number and alignment of service territories and respective representatives therefor.

### BACKGROUND OF THE INVENTION

One of the most significant challenges for every company or organization that is in the business of selling products and/or providing services is the optimization of resource allocation in such a way as to maximize revenues while minimizing the associated costs. As is well known, a significant part of this optimization is focused on the creation and maintenance of efficient service and/or sales territories, and the hiring of the appropriate number of talented representatives for the these territories.

For example, in typical sales-oriented businesses, business managers have traditionally relied upon their “gut instincts” to intuitively determine if, when, and where to add new sales territories and/or sales representatives. Thus, in the past, such determinations have been made based on factors that include, for example, the existing sales territories of competitors; where competitors'sales representatives live; where the business's own sales representatives currently live; the business manager's gut feeling about how large a given sales territory should be; and the perceived distribution of the business's existing customers.

This approach, however, has generally resulted in sales territories that may be too large with respect to geographical size, and/or number of actual or prospective customers, to be properly managed by a single sales representative. That is, given his/her responsibilities vis-á-vis his/her existing customers, as well as the size of his/her territory, a single sales representative is usually unable to travel as much as is needed to meet with, attract, and retain new customers/clients. As such, most sales representatives are re-active, rather than pro-active, and are therefore unable to tap into the untapped potential business in their respective sales territories. On the other hand, sales representatives are often very resistant to having the size of their sales territory reduced based on the perception that doing so would cause a reduction in their client base and, therefore, their sales-production-based income.

What is needed, therefore, is a fact-based, pro-active approach for creating, or re-aligning, service (or sales) territories in such a way as to allow a business to deploy its representatives to both manage their existing clients efficiently, and attract and retain potential clients within their respective territories, for the mutual benefit of the business and their representatives.

### BRIEF DESCRIPTION OF THE DRAWINGS

FIG. 1 is a flow chart depicting various steps of an optimization process in accordance with an embodiment of the invention;

FIG. 2 shows various aspects of a service territory analysis in accordance with an embodiment of the invention;

FIG. 3 shows a service territory and businesses with untapped potential in and around the territory according to an analysis performed using an embodiment of the invention; and

FIG. 4 shows a before-and-after comparison of territorial distribution according to an embodiment of the invention.

### DETAILED DESCRIPTION

In light of the above-mentioned need, the instant invention is directed to a method and system for quantifying untapped business potential on a territory-by-territory basis, and then using the information in an iterative process to determine when a new territory should be created, or existing territories reconfigured, and new representatives added to the staff.

It is noted that, although, throughout the ensuing discussion, the example of a sales-related organization is used, such use is for illustrative purposes only, and the principles of the instant invention may be used in optimizing the geographical allocation of resources for any type of organization, regardless of whether the organization is non-profit, for-profit, governmental, etc., and regardless of the specific sector of the economy (e.g., sales, service, manufacturing, consulting, etc.) in which the organization operates. In this regard, the phrases “service territory” and “service representative” are used herein to refer, generically and respectively, to the geographical territory in which such an organization may operate, and the organization's representative(s) in that territory.

In addition, certain aspects of the invention will be illustrated hereinafter by way of an example of a company that provides (i.e., sells) financing services to manufacturer's dealers. In this example, the resources to be allocated include the company's sales representatives, and the geographical boundaries to be optimized are those of the company's sales territories. However, here, again, this example is used by way of illustration, and not limitation.

As noted, aspects of an embodiment of the instant invention will be described with reference to a for-profit company, Company A, that offers financing to manufacturer's dealers, i.e., a company that finances consumer durable goods inventories while those goods are at a dealer's showroom. The company has sales (i.e., service) territories and representatives distributed across the United States, although, again, application of the principles of the invention are not limited to a specific state, country, or geographical location.

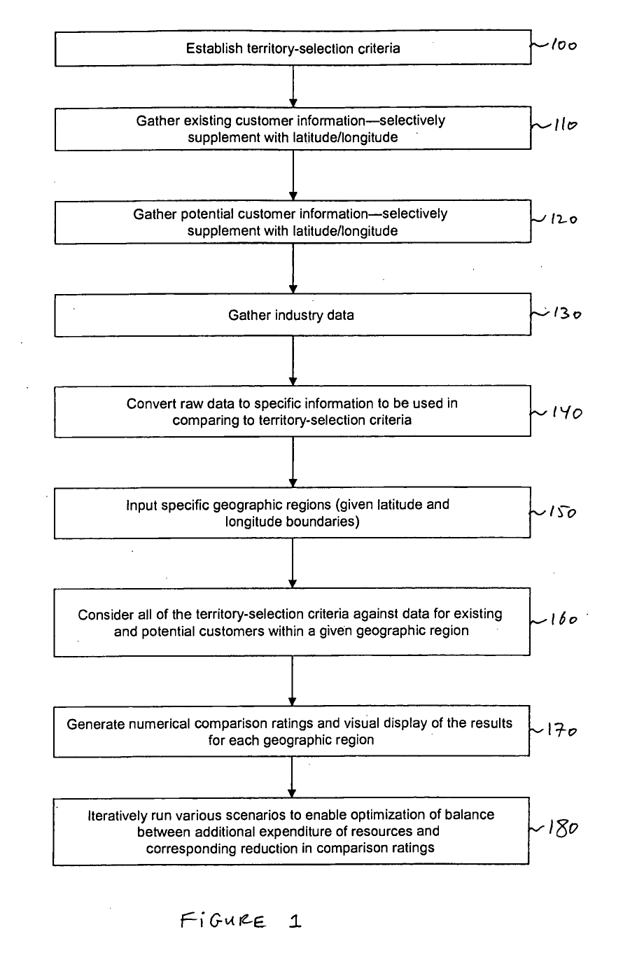

As shown in FIG. 1, the first step 100 of the methodology according to an embodiment of the invention is the establishment of territory-selection criteria. That is, in step 100, specific quantitative criteria are identified that are deemed to be relevant for determining territorial boundaries. For example, one criterion might be the maximum distance that a service representative can comfortably travel within a territory. A second may be the number of existing customers that the service representative can adequately service. These, and other territory-selection criteria may be identified by surveying the service force (e.g., service representatives, regional managers, etc.), customers, and/or management-level decision makers. In addition, the number of criteria is not limited and, for each specific situation, as many criteria as are deemed necessary may be used. However, in embodiments of the invention, 3-5 criteria may be chosen for ease of implementation.

For the specific example herein, Company A starts by compiling a list of various territory-selection criteria, or factors, which are established based on the specific experiences of Company A and/or its customers. Thus, in accordance with one embodiment of the invention, the territory-selection criteria may be identified by conducting voice-of-customer (VOC) surveys, in which Company A's customers may be asked to provide information and feedback in connection with various aspects of their relationship with Company A. Additionally, or alternatively, Company A's key stakeholders, managers, and sales representatives may be surveyed in order to collect this information based on their experiences and/or feedback that has been provided to them, directly or indirectly, by the Company's customers.

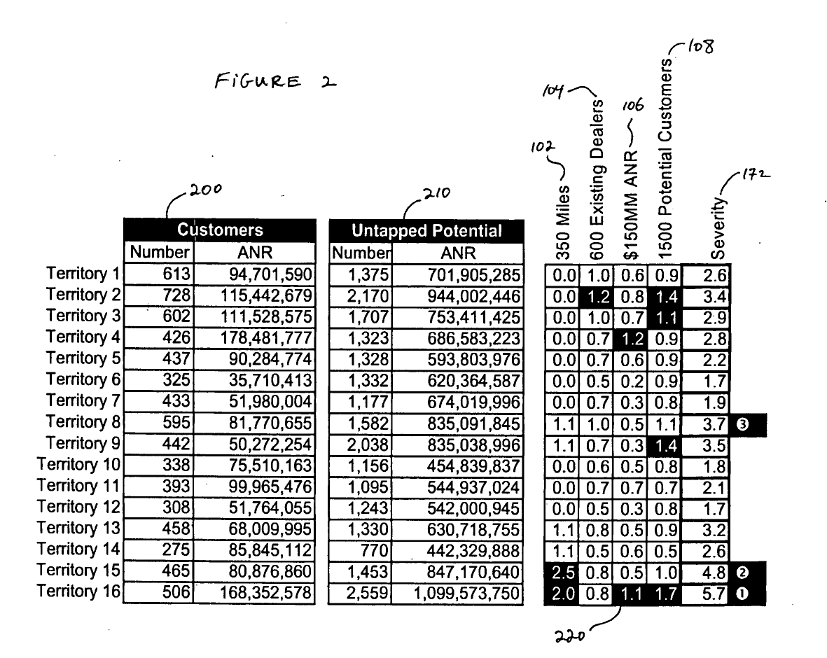

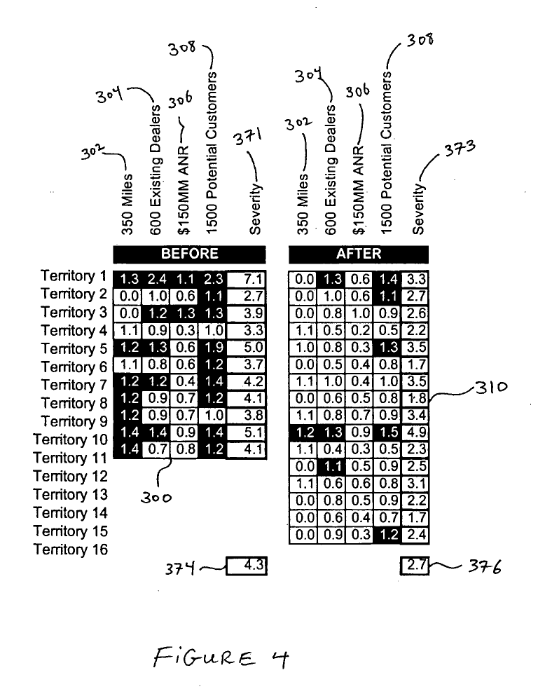

Having conducted the VOC surveys, and/or collected any internal feedback as applicable, Company A settles on the following 4 territory-selection criteria: distance, number of existing customers, number of potential customers, and business activity measures from existing customers. Specifically, Company A has decided that: (1) no part of any territory should be more than 350 miles away from the sales representative's home base; (2) no territory should have more than 600 existing customers that must be serviced; (3) no territory should have more than 1500 potential new customers; and (4) no territory should have more than $150 million in existing receivables. These criteria are also shown in connection with Table 220 in FIG. 2, and Tables 300 and 310 in FIG. 4, all of which will be discussed in more detail below.

In step 110, information regarding existing customers is gathered to the extent necessary to evaluate the criteria identified in step 100. For example, if annual revenue is determined to be a criterion established in step 100, then the information, or data to be gathered in connection with existing customers must include revenue (e.g., annual revenues) for each existing customer. In addition, in this step, latitude and longitude coordinates are also obtained for each existing customer's current location.

In general, the above information is readily available for each organization's existing customers. Nevertheless, where some of the information, such as, e.g., latitude/longitude coordinates, is not readily available, a freely-available “ZIP-to-Coordinates” data file may be used to obtain specific latitude/longitude coordinates by using the customer's zip code.

For the specific example herein, Chart 200 in FIG. 2 shows some of the information that is gathered by Company A in connection with its existing customers in each of its existing sales territories. Thus, as shown in Chart 200, Territory 1, for example, has 613 existing customers, with combined annual net receivables (ANR) of $94,701,590.00, and Territory 11 has 393 existing customers, with an ANR of $99,965,476.00. Here, a ZIP-to-Coordinates data file was used to provide latitude/longitude coordinates for each existing customer which, in turn, determined the specific territory in which that customer was grouped. In addition, Company A's existing business reports provided the ANR figures for each existing customer.

Next, at step 120, potential-customer information is gathered in a two-stage process. In the first step, commercially-available databases, such as Dun & Bradstreet®, InfoUSA®, etc. are used to compile potential-customer information, which may then be supplemented with longitude/latitude data. For example, depending on the organization's specific industry or type of business activity, one or more of the above-mentioned databases may be searched using Standard Industrial Classification (SIC) codes. The supplemental location data, if available, may be imported into mapping software, such as, e.g., Microsoft MapPoint®, to graphically illustrate the location of each data point.

For the example herein, Company A searched various targeted businesses within, e.g., the InfoUSA® database to obtain the SIC code for each business, and then used the SIC codes, along with the longitude/latitude coordinates of each of its existing territories, to compile a listing of all of the customers that may be located within each of its existing sales territories. The SIC codes used in the latter search included:

| | |
|---|---|
| 508310 | Farm Equipment - Wholesale |
| 526101 | Lawn and Garden Equipment and Supplies-Retail |
| 526114 | Outdoor Power Equipment |
| 527102 | Mobile Home Dealers |
| 555104 | Boat Dealers |
| 556103 | RVs |
| 556108 | Motor Homes |
| 559902 | Trailers-Utility, etc. |
| 559903 | Trailers |
| 559917 | Trailer Sales |
| 573602 | Pianos |
| 573608 | Musical Instruments |
| 599917 | Hot tubs, Spas |

The above search results, however, may include Company A's existing customers, as well as irrelevant, incorrect, or duplicative information. Thus, the second stage of step 120 is directed to filtering the results by reviewing the search results and removing anomalies or unwanted data. This process of “purifying” or “de-duping” of the data, therefore, involves sorting and re-sorting of the data to identify “outliers”. For example, Company A found, through a search for “movers” within the piano SIC code (573602), that approximately 100 companies that were piano movers were included in the “piano” SIC code. Being interested in piano dealers (and their retail sales of pianos), Company A then removed the piano movers from the compiled results.

The de-duping process may also involve searching for duplicate locations, and removing the oldest entity. Such duplication may be caused by a change in a business'name, in which case the results may include multiple business entities having the same address. In this case, one of the two identical entries is removed. Occasionally, the latitude and longitude for two entries may be identical, but the street address or business type may be different. This may occur, for example, when two businesses are located very close to one another, such as, e.g., in the same strip mall.

Once “outliers” have been identified, they are brought to the attention of management, who must verify (i.e., confirm or reject) the data. In addition, random samples may be pulled and given to sales staff to confirm the accuracy of the data. For example, sales representatives may be asked to provide the names of a plurality of businesses within their respective territories. The search results would then be checked to determine if any of these businesses are missing. Once a determination has been made that pertinent data may be missing from the compiled search results, appropriate corrective measures may be taken. For example, the database may be searched for the missing business to determine the business's primary SIC code, which is then used to search for additional businesses having this (new) SIC code.

Ultimately, the filtering and verification processes must produce data that fall within a given range of accuracy, or acceptance. Thus, in the instant example, Company A decided that two-tailed 80% accuracy (i.e., 10% upper and lower) would be acceptable. The left column of Chart 210 in FIG. 2 shows the number of potential customers in each of the 16 territories that were used in one of the scenarios for Company A.

In steps 130 and 140, the data that was collected and compiled in step 120 must be translated into untapped business opportunity in a way that can be compared to the territory-selection criteria established in step 100. This is achieved by first gathering industry data (step 130).

Characteristics of the industry in which the organization is interested are gathered independently. For example, a pharmaceutical company might be interested in the relationship between the number of physicians in a medical group, on the one hand, and the average number of prescriptions written, or the dollar value of prescriptions written, and type of practice, on the other. Or, it may be that, for a given industry, or a specific type of business, a relationship needs to be established between the number of employees in an organization and revenue size. These and other such relationships, or supplemental industry-related data, may be collected from a number of sources, including, e.g., business databases, Risk Management Association publications, Census Bureau data, and consensus viewpoint of management.

In our specific example, given its line of business, Company A needs to compute an estimate for the value of the wholesale inventory (of potential customers) that the Company would like to finance. To do this, the company accesses the above-noted (and/or similar) sources to derive, for each SIC code category, a factor that is indicative of the potential customers' average retail markup, as well as an number that is indicative of the potential customers'typical inventory turns.

Step 140 is directed to answering the question “how is the data collected converted to business opportunity?” Thus, in this step, the industry data that was collected in step 130 is applied to the “raw” data that was gathered in step 120 to convert the latter to specific useable information that can be measured against, or compared to, the criteria established in step 100. For example, if a criterion of interest is that targeted customers must have at least 2 personal computers (PCs) within their business, then this step may be geared towards converting annual revenues (step 120) to estimated number of PCs (step 140) based on industry norms (step 130).

As noted, in the specific example, Company A needed to estimate average amounts of wholesale inventory on hand. To do this, it needed to translate the number of employees to retail sales figures—unless retail sales were known, e.g., from one of the databases mentioned above—and then apply the factors noted above for retail markup and inventory turns to the retail sales figures to arrive at the estimated wholesale inventory amounts. Thus, the figures for specific dealers' sales were multiplied by a factor representing the percentage of what Company A believed to be its market share (from the untapped business potential). Then, the result was modified by a factor representing the amount of time the Company believed it would take for the dealers' products to be sold, i.e., the amount of inventory turnover, such that the dealer might require financing for new products. The right column of Chart 210 in FIG. 2 contains the resultant information in dollar amounts for each territory.

As mentioned previously, retail-markup and inventory-turns factors are varied by SIC code. Therefore, Company A employed Microsoft Excel® “vlookup” functions to apply the factors, as well as market-share estimates, to the “raw” data. However, any number of commercially-available software applications may be used to perform this function.

In steps 150, 160, and 170, latitude and longitude boundaries are utilized as input parameters into, e.g., a map-generation program or similar commercially-available software in order to generate specific geographical territories in which the organization does, or may want to do, business. Taking the results of step 140, each of these territories is then used to determine the extent to which the territory-selection criteria match up with the combination of existing- and potential-customer information in that territory.

As will be explained hereinbelow, the comparison is made by way of comparative ratings, hereby referred to as “severity ratings”. In one embodiment of the invention, these ratings comprise relative ratios calculated for each of the selection criteria with respect to each geographical region and, as the name implies, are indicative of the level of severity of the mismatch between the selection criteria and the customer information. As will also be explained hereinbelow, this is an iterative process, wherein, in each iteration, a scenario is constructed for which the number of territories and/or the boundaries of at least one of the territories may be different from that of the previous iteration/scenario.

Going back to step 150, in an embodiment of the invention, the existing- and potential-customer data may be sorted first by state, and then by longitude. Thus, for example, one territory may be defined as New York, south of Interstate 90. The boundaries of this territory, in turn, would be defined as NY State, south of 42.97 degrees. Therefore, all data elements (i.e., customer locations) falling below 42.97 degree are considered to be located within a first territory, S-NY, and all data elements falling above 42.97 degrees are considered to be located in a second territory, N-NY.

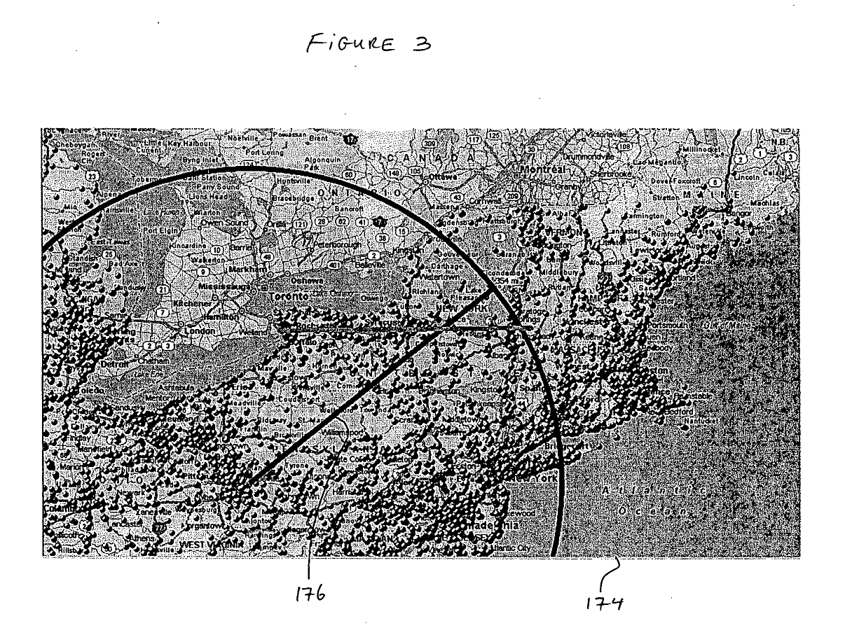

Thus, for the example considered herein, Company A's New York-region territories, i.e., S-NY and N-NY, would appear as shown in regional map 174 in FIG. 3, in which the line 176 defines the radius of the area that is within a defined distance from a sales professional's home base. A similar process is then implemented for all of the other geographic regions that may be desired in the scenario under consideration.

It is noted that, for the example of Company A, Microsoft Excel® pivotlookup functions and vlookup formulas were used to organize the customer information in tabular format, based on which visual maps could then be generated. However, again, any number of commercially-available programs or software packages may be used to implement this process.

Once all of the territories of a given scenario have been determined, comparison ratings are calculated for each territory (steps 160 and 170). For Company A, Table 220 in FIG. 2 shows the ratings for a scenario that includes 16 territories. Here, the territory-selection criteria 102, 104, 106, 108 are the ones that were established in step 100. As can be seen from FIG. 2, each column of Table 220 represents a rating that is indicative of the comparison between a specific criterion and a specific item of existing- or potential-customer information.

More specifically, in an embodiment of the invention, each of the ratings in Table 220 represents a ratio of one specific item of customer information to a corresponding one of the territory-selection criteria. Thus, a rating value of 1.0 indicates that the customer information is substantially at par with the selection criterion, a value that is less than 1.0 indicates that the customer information falls below the selection-criterion threshold, and a value that is greater than 1.0 indicates that the customer information is above the desired upper limit of the criterion.

For example, for Territory 1, the rating of “0.0” in the first (i.e., left-most) column of Table 220 (corresponding to criterion 102) indicates that the boundaries of this territory are within 350 miles of the sales representative's home base. Similarly, a rating of “1.0” in the second column indicates that Territory 1 contains about 600 existing customers (criterion 104), where the rating is calculated as 613/600. The rating of “0.6” (calculated as 94,701,590/150,000,000) in the third column indicates that existing receivables are below the upper limit of criterion 106, and the rating of “0.9” (calculated as 1375/1500) in the fourth column indicates that there are fewer than 1500 potential businesses (criterion 108) in Territory 1.

The ratings for all of the remaining territories are calculated in the same way. Then, for each territory, an overall, or “severity”, rating 172 is calculated by adding all of the ratings for that territory. As noted previously, the severity ratings are indicative of the level of severity of the mismatch between the selection criteria and the customer information for a given territory. Put another way, the severity ratings indicate which of the territories are the closest to being optimal, and which are sub-optimal, given the established territory-selection criteria. With this in mind, several of the territories with the highest severity ratings may be identified as candidates for geographical reconfiguration in the next iteration. Such reconfiguration may be achieved by realigning the boundaries of one or more territories, wherein each reconfigured territory may be split into two or more territories, thereby generating a new set of territories in the next iteration.

For the example shown in FIG. 2, Territory 16 (severity rating 5.7), Territory 15 (severity rating 4.8), and Territory 8 (severity rating 3.7) have been identified for possible reconfiguration in a subsequent scenario. In an embodiment of the invention, the most sub-optimal territories are determined by comparing, in each iteration, the severity rating for each territory to an average severity rating which is calculated as the mathematical average of the severity ratings for all of the territories.

With one or more sub-optimal territories identified, the process of reconfiguring geographical boundaries of (existing) territories is then repeated (step 180), each time yielding a new set of severity ratings for a new set of territories, until an optimal balance is iteratively achieved between the selection criteria and the territorial distribution. In striking this balance, each time the process is repeated, the territories with the highest severity ratings are realigned and/or split up in order to lower the severity ratings, while, at the same time, causing as little impact as possible to the territories whose severity rating is closer to the average. In step 180, after two or more scenarios have been modeled, a decision can be made as to whether additional expenditure of resources (e.g., addition of another territory, hiring of another sales representative for the territory, etc.) would be justified by the corresponding incremental reduction in the relative severity ratings.

A set of scenarios for Company A is shown in FIG. 4. Here, a first scenario consisted of a total of 11 territories; for brevity, existing- and potential-customer information are not shown. As can be seen from Table 300, in all of the territories, at least one of the ratings is sub-optimal, i.e., out of compliance with at least one of the territory-selection criteria 302, 304, 306, and 308 within Table 300. This resulted in severity ratings 371 as high as 7.1 (for Territory 1), and an average severity rating 374 of 4.3.

Given this scenario, several iterations were run, whereby the original 11 territories were reconfigured, and new territories created. The end result, shown in Table 310, was that compliance with the territory-selection criteria 302, 304, 306, and 308 was substantially improved, as indicated by an average severity rating 376 of 2.7. As noted previously, it might have been possible to lower the severity ratings 373 even more, so as to achieve an even lower average rating 376. However, in this example, it was decided by Company A that any additional improvements in the average severity rating would not be justified by the associated cost of the additional resources that would be required.

As can be seen from the above description, the instant invention offers numerous advantages vis-a-vis the above-mentioned shortcomings in the existing art. First, when it is decided that an existing service territory should be reduced in size (e.g., by splitting the territory into a number of smaller territories), the territory's service representative's fear of reduced sales opportunities and resulting reduced income is addressed by the fact that the smaller territory includes an untapped potential that, when combined with the representative's existing client base, matches, and may even surpass, his/her previous opportunities and income from the existing, larger territory. In addition, because the territory is now smaller, it is more manageable, and allows the service representative to travel more frequently, and for shorter distances, than before. As such, the service representative is able to capitalize on additional opportunities and provide customer or client support much faster and more efficiently than was previously possible. Significantly, the above opportunities can be presented to service representatives visually.

Second, the invention aids in the recruitment of highly sought-after service representatives by allowing a business manager to present to the recruit the quantity of untapped potential that exists in the split-up/new territory. This is significant because, in conjunction with the first advantage noted above, it creates a ripple effect, whereby an existing territory can be split up, with the new recruit representing the newly-created territory, and the existing representative having a more manageable territory in terms of customer coverage and support, and each representative pursuing untapped potential in each respective territory.

While the description above refers to particular embodiments of the present invention, it will be understood that modifications may be made without departing from the spirit thereof. For example, some or all of the aspects of the invention may be practiced by using a computer system, including a CPU, memory, input and output interfaces, communication interface(s), etc. The accompanying claims are therefore intended to cover such modifications as would fall within the true scope and spirit of the present invention.

What is claimed is:

1. A method for using a computer processing system to optimize allocation of a business entity's resources based on an existing set of the entity's geographical service territories, each said territory having located therein a first group of existing customers and a second group of potential customers, the method comprising:
(a) storing a plurality of territory-selection criteria;
(b) accessing an electronic database to compile, for each of the entity's existing service territories, customer-specific data for each existing customer and for each potential customer;
(c) based on the data compiled for each potential customer, calculating an overall potential business opportunity for each of the existing service territories;
(d) calculating the entity's market share of the potential business opportunity for each of the existing service territories;
(e) for each existing territory, calculating a plurality of ratings, each said rating representing a comparison between a selected one of said territory-selection criteria and a corresponding selected one of said customer-specific data; and
(f) based on said plurality of ratings for each existing territory, reconfiguring geographical boundaries of at least one of the entity's existing service territories to generate a new set of service territories.

2. The method of claim 1, wherein, for each existing service territory, said territory-selection criteria include one or more members selected from the group consisting of an upper limit on the number of existing customers, an upper limit on the distance from the territory's boundaries to a service representative's home base, an upper limit on the amount of existing receivables, and an upper limit on the number of potential customers.

3. The method of claim 1, wherein each said rating is a ratio of a number derived from said selected one of the compiled customer-specific data and said selected one of the territory-selection criteria.

4. The method of claim 1, wherein said customer-specific data includes the number of existing customers, the number of potential customers, and each existing and potential customer's business name, business address, relevant industry, and financial information.

5. The method of claim 1, further including:
calculating, for each existing service territory, an overall rating by adding the plurality of ratings for the territory;
calculating a first average value of the overall ratings for all of the existing territories; and
in step (f), generating the new set of service territories in such a way as to reduce said first average value.

6. The method of claim 5, wherein, in step (f), said reconfiguration of geographical boundaries includes splitting an existing service territory to generate at least two new service territories.

7. The method of claim 5, further including, after generation of the new set of service territories:
(g) for each new service territory, re-calculating the plurality of ratings;
(h) for each new service territory, calculating a revised overall rating by adding the re-calculated plurality of ratings for the new territory;
(i) calculating a revised average value of the revised overall ratings; and
(j) comparing the revised average value to the first average value to determine the impact of the reconfiguration of the geographic boundaries on said first average value.

8. The method of claim 7, further including iteratively repeating steps (f)-(j), wherein, for each iteration, the existing service territories for use in step (f) are represented by the new service territories obtained from step (f) of the immediately-preceding iteration.

9. The method of claim 5, further including accessing a geographical map configured to contain latitude and longitude coordinates, such that step (f) is accomplished by changing the coordinates of the at least one existing service territory to generate the new set of service territories.

10. The method of claim 1, wherein each said service territory is a sales territory.

11. The method of claim 10, wherein the entity's market share of the potential sales opportunity is calculated based on one or more factors selected from the group consisting of an estimated share of the overall potential business opportunity and an average inventory turn-over time.

12. The method of claim 1, wherein the electronic database is a commercially-available database.

13. A method of optimizing allocation of a business entity's sales resources based on an existing set of the entity's geographical sales territories, each said territory having located therein a first group of existing customers and a second group of potential customers, said method comprising:
(a) establishing a plurality of territory-selection criteria;
(b) providing a computer processing system for performing the steps of:
accessing an electronic database to compile, for each of the entity's existing sales territories, customer-specific data for each existing customer and for each potential customer;
based on the data compiled for each potential customer, calculating an overall potential sales opportunity for each of the existing sales territories;
calculating the entity's market share of the potential sales opportunity for each of the existing sales territories; and
for each existing territory, calculating a plurality of ratings, each said rating representing a comparison between a selected one of said territory-selection criteria and a corresponding selected one of said customer-specific data; and
(c) based on said plurality of ratings for each existing territory, reconfiguring geographical boundaries of at least one of the entity's existing sales territories to generate a new set of sales territories.

14. The method of claim 13, wherein the computer system further performs the steps of:
calculating, for each existing sales territory, an overall rating by adding the plurality of ratings for the territory; and
calculating a first average value of the overall ratings for all of the existing territories, such that, in step (c), the new set of sales territories is generated in such a way as to reduce said first average value.

15. The method of claim 14, wherein, in step (c), said reconfiguration of geographical boundaries includes splitting an existing sales territory to generate at least two new sales territories.

16. The method of claim 14, further including, after generation of the new set of sales territories:
(d) for each new sales territory, re-calculating the plurality of ratings;
(e) for each new sales territory, calculating a revised overall rating by adding the re-calculated plurality of ratings for the new territory;
(f) calculating a revised average value of the revised overall ratings; and
(g) comparing the revised average value to the first average value to determine the impact of the reconfiguration of the geographic boundaries on said first average value.

17. The method of claim 16, further including iteratively repeating steps (c)-(g), wherein, for each iteration, the existing sales territories for use in step (c) are represented by the new sales territories obtained from step (c) of the immediately-preceding iteration.

18. The method of claim 14, further including accessing a geographical map configured to contain latitude and longitude coordinates, such that step (c) is accomplished by changing the coordinates of the at least one existing sales territory to generate the new set of sales territories.

19. A machine-readable medium embodying a program of instructions which, when executed, causes a machine to perform a process of optimizing allocation of a business entity's resources based on an existing set of the entity's geographical service territories, each said territory having located therein a first group of existing customers and a second group of potential customers, the process comprising:
(a) storing a plurality of territory-selection criteria;
(b) accessing an electronic database to compile, for each of the entity's existing service territories, customer-specific data for each existing customer and for each potential customer;
(c) based on the data compiled for each potential customer, calculating an overall potential business opportunity for each of the existing service territories;
(d) calculating the entity's market share of the potential service opportunity for each of the existing service territories;
(e) for each existing territory, calculating a plurality of ratings, each said rating representing a comparison between a selected one of said territory-selection criteria and a corresponding selected one of said customer-specific data; and
(f) based on said plurality of ratings for each existing territory, reconfiguring geographical boundaries of at least one of the entity's existing service territories to generate a new set of service territories.

20. The machine-readable medium of claim 19, wherein the process further includes:
calculating, for each existing service territory, an overall rating by adding the plurality of ratings for the territory;
calculating a first average value of the overall ratings for all of the existing territories; and
in step (f), generating the new set of service territories in such a way as to reduce said first average value.

21. The machine-readable medium of claim 20, wherein, in step (f), said reconfiguration of geographical boundaries includes splitting an existing service territory to generate at least two new service territories.

22. The machine-readable medium of claim 20, wherein the process further includes, after generation of the new set of service territories:
(g) for each new service territory, re-calculating the plurality of ratings;
(h) for each new service territory, calculating a revised overall rating by adding the re-calculated plurality of ratings for the new territory;
(i) calculating a revised average value of the revised overall ratings; and
(j) comparing the revised average value to the first average value to determine the impact of the reconfiguration of the geographic boundaries on said first average value.

23. The machine-readable medium of claim 22, the process further including iteratively repeating steps (f)-(j), wherein, for each iteration, the existing service territories for use in step (f) are represented by the new service territories obtained from step (f) of the immediately-preceding iteration.

24. The machine-readable medium of claim 22, the process further including accessing a geographical map configured to contain latitude and longitude coordinates, such that step (f) is accomplished by changing the coordinates of the at least one existing service territory to generate the new set of service territories.

25. The machine-readable medium of claim 19, wherein, for each existing service territory, said territory-selection criteria include one or more members selected from the group consisting of an upper limit on the number of existing customers, an upper limit on the distance from the territory's boundaries to a service representative's home base, an upper limit on the amount of existing receivables, and an upper limit on the number of potential customers.

26. The machine-readable medium of claim 19, wherein each said rating is a ratio of a number derived from said selected one of the compiled customer-specific data and said selected one of the territory-selection criteria.

27. The machine-readable medium of claim 19, wherein said customer-specific data includes the number of existing customers, the number of potential customers, and each existing and potential customer's business name, business address, relevant industry, and financial information.

28. The machine-readable medium of claim 19, wherein the electronic database is a commercially-available database.
